(19) United States
(12) Patent Application Publication
(10) Pub. No.: US 2012/0042807 A1
(43) Pub. Date: Feb. 23, 2012

(54) POWDER FOR THERMAL SPRAYING AND METHOD FOR FORMING THERMAL-SPRAY DEPOSIT

(75) Inventors: Kazuto Sato, Gifu (JP); Junya Kitamura, Gifu (JP)

(73) Assignee: Fujimi Incorporated, Aichi (JP)

(21) Appl. No.: 13/318,313

(22) PCT Filed: Jun. 4, 2010
(86) PCT No.: PCT/JP2010/059520

§ 371 Date: Oct. 31, 2011

(30) Foreign Application Priority Data
Jun. 10, 2009 (JP) 2009-139346
Jun. 1, 2010 (JP) 2010-125811

(51) Int. Cl. C04B 7/00

(52) U.S. Cl. 106/816

(57) ABSTRACT

Disclosed is a thermal spray powder of granulated and sintered cermet particles. The granulated and sintered cermet particles have an average particle size of 5 to 25 μm. The particles have a compressive strength of 50 MPa or higher. The particles have a straight ratio of 0.25 or higher, the straight ratio being defined as a value resulting from dividing the maximum thickness of a thermal spray coating obtained, when 150 grams of the thermal spray powder is subjected to thermal spot spraying, by the length of the longest of line segments each of which has both ends thereof on a contour of the spray coating. The granulated and sintered cermet particles have an average aspect ratio of preferably 1.25 or lower. The thermal spray powder is preferably used in applications where a thermal spray coating is formed by high-velocity flame spraying or cold spraying.

### TECHNICAL FIELD

The present invention relates to a thermal spray powder of granulated and sintered cermet particles, and a method for forming a thermal spray coating by using the thermal spray powder.

### BACKGROUND ART

A thermal spray coating of cermet has been used in various industrial fields, and extensive developments of thermal spray powders for the purpose of further improving the performance of such a thermal spray coating have been conducted (e.g., refer to Patent Document 1). However, improvement of the hardness and abrasion resistance of the thermal spray coating has been still highly required.

### PRIOR ART DOCUMENTS

Patent Document 1: Japanese Laid-Open Patent Publication No. 2008-69386

### SUMMARY OF THE INVENTION

### Problems that the Invention is to Solve

Accordingly, an objective of the present invention is to provide a thermal spray powder suitable for forming a thermal spray coating having good hardness and abrasion resistance.

Another objective of the present invention is to provide a method for forming a thermal spray coating by using the thermal spray powder.

### Means for Solving the Problems

In order to attain the above objectives, the present inventors have made extensive studies focusing attention on straight moving property of particles in the thermal spray powder at the time of thermal spraying, as a factor which affects characteristics of a thermal spray coating formed from the thermal spray powder. As a result, the present invention has been accomplished.

A first aspect of the present invention provides a thermal spray powder of granulated and sintered cermet particles. The granulated and sintered cermet particles have an average particle size of from 5 to 25 μm. The granulated and sintered cermet particles have a compressive strength of 50 MPa or higher. The granulated and sintered cermet particles have a straight ratio of 0.25 or higher, the straight ratio being defined as a value resulting from dividing the maximum thickness of a thermal spray coating obtained, when 150 grams of the thermal spray powder is subjected to thermal spot spraying, by the length of the longest of line segments each of which has both ends thereof on a contour of the thermal spray coating.

The granulated and sintered cermet particles have an average aspect ratio of preferably 1.25 or lower. Primary particles constituting the granulated and sintered cermet particles have an average particle size of preferably 6.0 μm or lower. Metal primary particles constituting the granulated and sintered cermet particles have a dispersibility of preferably 0.40 or lower, the dispersibility being defined as a value obtained by dividing a number average size of the metal primary particles by a volume average size of the metal primary particles. The compressive strength of the granulated and sintered cermet particles is preferably 1000 MPa or lower. The granulated and sintered cermet particles have an average fractal dimensionality of preferably 1.075 or lower.

A second aspect of the present invention provides a method for forming a thermal spray coating, wherein the thermal spray powder of the first aspect is subjected to high-velocity flame spraying or cold spraying to form a thermal spray coating. That is, the thermal spray powder of the first aspect is used for the purpose of forming a thermal spray coating preferably by high-velocity flame spraying or cold spraying.

### Effects of the Invention

The present invention provides a thermal spray powder suitable for forming a thermal spray coating having good hardness and abrasion resistance, and a method for forming a thermal spray coating by using the thermal spray powder.

### MODE FOR CARRYING OUT THE INVENTION

One embodiment of the present invention will be described below.

A thermal spray powder of the present embodiment includes granulated and sintered cermet particles. The thermal spray powder is used for the purpose of forming a cermet thermal spray coating, for example, by high-velocity flame spraying such as high-velocity air fuel (HVAF) thermal spraying and high-velocity oxygen fuel (HVOF) thermal spraying.

The granulated and sintered cermet particles contained in the thermal spray powder are composite particles in which ceramic fine particles and metal fine particles are agglomerated with each other. The granulated and sintered cermet particles are prepared by granulating a mixture of the ceramic fine particles with the metal fine particles and sintering the resultant particles (granulated particles). The ceramic fine particles may be particles of a carbide such as tungsten carbide and chromium carbide, particles of a boride such as molybdenum boride and chromium boride, particles of a nitride such as aluminum nitride, particles of a silicide, particles of an oxide, or any combinations of these particles. The metal fine particles may be particles of elemental metal such as cobalt, nickel, iron, and chromium, particles of metal alloy, or any combinations of these particles.

It is preferred that the content of the metal fine particles in the granulated and sintered cermet particles be from 5 to 40% by volume. In other words, it is preferred that the content of the ceramic fine particles in the granulated and sintered cermet particles be from 60 to 95% by volume.

The thermal spray powder has the lower limit of 0.25 in respect to a straight ratio of the granulated and sintered cermet particles defined as follows. The straight ratio is a value obtained by dividing the maximum thickness of a thermal spray coating obtained, when 150 grams of the thermal spray powder is subjected to thermal spot spraying on a substrate, by the length of the longest of line segments each of which has both ends thereof on a contour of the thermal spray coating. The straight ratio is an index showing at what degree the thermal spray powder goes straight to the substrate at the time of thermal spraying. A higher straight ratio shows that a larger amount of the granulated and sintered cermet particles goes straight to the substrate at the time of thermal spraying. With an increase in the straight ratio, the rate of formation of a thermal spray coating per unit quantity of the thermal spray powder, i.e., deposition efficiency (thermal spraying yield) tends to increase. Additionally, the hardness and abrasion resistance of a thermal spray coating formed from the thermal spray powder also tend to be improved.

It is thought that this is because granulated and sintered cermet particles having a high straight ratio are efficiently accelerated at the time of thermal spraying and, as a result, collide with the substrate at a higher velocity. A thermal spray powder of granulated and sintered cermet particles having a straight ratio of 0.25 or higher is particularly advantageous in forming a thermal spray coating having required hardness and abrasion resistance. From the viewpoint of further improvement of the hardness and abrasion resistance of the thermal spray coating, the straight ratio of the granulated and sintered cermet particles is preferably 0.27 or higher, and more preferably 0.30 or higher.

The lower limit of the average particle size (volume average size) of the granulated and sintered cermet particles is 5 μm. With an increase in the average particle size of the granulated and sintered cermet particles, the amount of free fine particles decreases, which are contained in the thermal spray powder and may be excessively molten during thermal spraying, and as a result, generation of “spitting” tends to hardly occur. Spitting is a phenomenon where a deposition of excessively molten thermal spray powder on an inner wall of a nozzle of a thermal spray apparatus peels away from the inner wall at the time of thermal spraying to form a thermal spray coating and is admixed with the thermal spray coating. Spitting becomes a factor in lowering the performance of the thermal spray coating. When the average particle size of the granulated and sintered cermet particles is 5 μm or higher, it is easy to suppress generation of spitting at the time of thermal spraying of the thermal spray powder to a particularly suitable level for practical use. From the viewpoint of further suppressing generation of spitting, the average particle size of the granulated and sintered cermet particles is preferably 8 μm or higher, and more preferably 10 μm or higher.

The upper limit of the average particle size of the granulated and sintered cermet particles is 25 μm. With a decrease in the average particle size of the granulated and sintered cermet particles, a dense degree of the thermal spray coating formed from the thermal spray powder increases, and as a result, the hardness and abrasion resistance of the thermal spray coating tend to be improved. When the average particle size of the granulated and sintered cermet particles is 25 μm or lower, it is particularly advantageous in forming a thermal spray coating having required hardness and abrasion resistance from the thermal spray powder. From the viewpoint of further improvement of the hardness and abrasion resistance of the thermal spray coating, the average particle size of the granulated and sintered cermet particles is preferably 20 μm or lower, and more preferably 15 μm or lower.

The upper limit of the average aspect ratio of the granulated and sintered cermet particles is preferably 1.25, more preferably 1.20, and even more preferably 1.15. The aspect ratio is defined as a value which is obtained by dividing the length of the major axis of an elliptic sphere, which is the most approximate to an outer shape of one of the granulated and sintered cermet particles, by the length of the minor axis of the elliptic sphere. With a decrease in the average aspect ratio, deposition efficiency of the thermal spray powder tends to increase. Additionally, the hardness and abrasion resistance of the thermal spray coating formed from the thermal spray powder tend to be improved. It is thought that this is because granulated and sintered cermet particles having a small aspect ratio are efficiently accelerated at the time of thermal spraying and, as a result, collide with the substrate at a higher velocity. When the average aspect ratio of the granulated and sintered cermet particles is 1.25 or lower, more specifically 1.20 or lower, and even more specifically 1.15 or lower, it is easy to improve the hardness and abrasion resistance of the thermal spray coating to a particularly suitable level for practical use.

The granulated and sintered cermet particles have an average fractal dimensionality of preferably 1.075 or lower, more preferably 1.070 or lower, even more preferably 1.060 or lower, and most preferably 1.050 or lower. The average fractal dimensionality is a value quantifying an irregularity degree of the surfaces of the granulated and sintered cermet particles, and is one of indices showing the shape of the granulated and sintered cermet particles, as well as the average aspect ratio. With an increase in the irregularity degree of the surfaces of the granulated and sintered cermet particles, in other words, in the complexity of the shape of the granulated and sintered cermet particles, the average fractal dimensionality of the granulated and sintered cermet particles increases. Meanwhile, the average fractal dimensionality is a value within the range of 1 or higher but less than 2. It is easy to improve the hardness and abrasion resistance of the thermal spray coating to a particularly suitable level for practical use, when the average fractal dimensionality of the granulated and sintered cermet particles is 1.075 or lower, more specifically 1.070 or lower, even more specifically 1.060 or lower, and further specifically 1.050 or lower.

The lower limit of the compressive strength of the granulated and sintered cermet particles is 50 MPa. Granulated and sintered cermet particles having a high compressive strength are difficult to collapse. Therefore, a thermal spray powder of granulated and sintered cermet particles having a high compressive strength has a tendency that generation of free fine particles, which are generated due to a collapse of the granulated and sintered cermet particles before thermal spraying and may be excessively molten during the thermal spraying, is suppressed, and as a result, generation of spitting tends to hardly occur. When the compressive strength of the granulated and sintered cermet particles is 50 MPa or higher, it is easy to suppress generation of spitting at the time of thermal spraying of the thermal spray powder to a particularly suitable level for practical use. From the viewpoint of further suppressing generation of spitting, the compressive strength of the granulated and sintered cermet particles is preferably 80 MPa or higher, and more preferably 100 MPa or higher.

The upper limit of the compressive strength of the granulated and sintered cermet particles is preferably 1000 MPa, more preferably 800 MPa, and even more preferably 600 MPa. Granulated and sintered cermet particles having a low compressive strength are easily softened or molten by being heated by a heat source at the time of thermal spraying. Therefore, a thermal spray powder of granulated and sintered cermet particles having a low compressive strength has a tendency to enhance deposition efficiency. When the compressive strength of the granulated and sintered cermet particles is 1000 MPa or lower, more specifically 800 MPa or lower, and even more specifically 600 MPa or lower, it is easy to enhance deposition efficiency of the thermal spray powder to a particularly suitable level for practical use.

The upper limit of the average particle size (average Feret's diameter) of the primary particles (including both ceramic primary particles and metal primary particles) constituting the granulated and sintered cermet particles is preferably 6.0 μm, more preferably 5.0 μm, and even more preferably 4.5 μm. When the average particle size of the primary particles is 6.0 μm, more specifically 5.0 μm, and even more specifically 4.5 μm, it is easy to control the average particle size and average aspect ratio of the granulated and sintered cermet particles to 25 μm or lower and 1.25 or lower, respectively.

The upper limit of the dispersibility, as defined below, of the metal primary particles in the granulated and sintered cermet particles is preferably 0.40, more preferably 0.30, and even more preferably 0.25. The dispersibility is a value obtained by dividing a number average size of the metal primary particles by a volume average size of the metal primary particles. The dispersibility is an index showing a degree of a dispersion of the metal primary particles in the granulated and sintered cermet particles. A smaller dispersibility shows that the metal primary particles are dispersed more uniformly in the granulated and sintered cermet particles. When the dispersibility is 0.40 or lower, more specifically 0.30 or lower, and even more specifically 0.25 or lower, it is easy to control the average aspect ratio of the granulated and sintered cermet particles to 1.25 or lower.

According to the present embodiment, the following advantage is achieved.

A thermal spray powder of the present embodiment is extremely advantageous in forming a thermal spray coating having required hardness and abrasion resistance in high deposition efficiency from the thermal spray powder, because the granulated and sintered cermet particles have a small average particle size of from 5 to 25 μm, the granulated and sintered cermet particles have a high straight ratio of 0.25 or higher, and the granulated and sintered cermet particles have a high compressive strength of 50 MPa or higher. Therefore, a thermal spray powder of the present embodiment is suitable for forming a thermal spray coating having good hardness and abrasion resistance in high deposition efficiency.

The above embodiment may be modified as follows.

The granulated and sintered cermet particles in the thermal spray powder may contain components other than ceramics and metal, such as an unavoidable impurity and an additive.

The thermal spray powder may contain components other than the granulated and sintered cermet particles. However, it is preferred that the amount of the components other than the granulated and sintered cermet particles be as small as possible.

The thermal spray powder may be used for the purpose of forming a thermal spray coating by using a thermal spraying method other than high-velocity flame spraying including a relatively low-temperature thermal spraying process such as cold spray and warm spray and a relatively high-temperature thermal spraying process such as plasma thermal spraying.

Cold spray is a technology where a working gas, which is heated to a temperature lower than the melting point or softening temperature of the thermal spray powder, is accelerated to supersonic velocity and the thermal spray powder as a solid phase is brought into collision with a substrate at a high velocity by the accelerated working gas and thus a coating is formed on the substrate. In case of the relatively high-temperature thermal spraying process, in general a thermal spray powder, which is heated to a temperature not lower than the melting point or softening temperature, is sprayed onto a substrate, and thus thermal deterioration or deformation of the substrate can occur depending upon the shape or material of the substrate.

Therefore, a coating cannot be formed onto all substrates having any types of shapes or materials, and the shape and material of the substrate are limited. Additionally, the thermal spray powder is required to be heated up to the melting point or softening temperature, and thus an apparatus is large and conditions such as working space are limited. In contrast, cold spray is conducted at a relatively low temperature, and thus there is an advantage that thermal deterioration or deformation of the substrate hardly occurs, and an apparatus can be smaller than that of the relatively high-temperature thermal spraying process. Additionally, there is also an advantage in that the working gas used is not a combustion gas and thus is good for safety and is high in convenience for use on site.

In general, cold spray is classified into a high pressure type and a low pressure type according to the working gas pressure. That is, the case of a working gas pressure having the upper limit of 1 MPa is called a low pressure type cold spray, and the case of a working gas pressure having the upper limit of 5 MPa is called a high pressure type cold spray. In the high pressure type cold spray, an inert gas such as helium gas, nitrogen gas, and mixtures thereof is mainly used as the working gas. In the low pressure type cold spray, a gas the same as that used in the high pressure type cold spray or compressed air is used as the working gas.

In a case where a thermal spray powder of the above embodiment is used for the purpose of forming a thermal spray coating by the high pressure type cold spray, the working gas is supplied to a cold spray apparatus at a pressure of preferably from 0.5 to 5 MPa, more preferably from 0.7 to 5 MPa, even more preferably from 1 to 5 MPa, and most preferably from 1 to 4 MPa, and is heated to a temperature of preferably from 100 to 1000° C., more preferably from 300 to 1000° C., even more preferably from 500 to 1000° C., and most preferably from 500 to 800° C. The thermal spray powder is supplied to the working gas along the coaxial direction with the working gas at a feed rate of preferably from 1 to 200 g/minute, and more preferably from 10 to 100 g/minute. The distance between the substrate and the nozzle tip of the cold spray apparatus at the time of spraying, or in other words, the thermal spraying distance is preferably from 5 to 100 mm, and more preferably from 10 to 50 mm. The traverse velocity of the nozzle of the cold spray apparatus is preferably from 10 to 300 min/second, and more preferably from 10 to 150 mm/second. The thickness of the thermal spray coating formed is preferably from 50 to 1000 μm, and more preferably from 100 to 500 μm.

In a case where a thermal spray powder of the above embodiment is used for the purpose of forming a thermal spray coating by the low pressure type cold spray mainly using an inert gas such as helium gas, nitrogen gas, and mixtures thereof as the working gas, the working gas is supplied to a cold spray apparatus at a pressure of preferably from 0.3 to 0.6 MPa, and more preferably from 0.4 to 0.6 MPa, and is heated to a temperature of preferably from 100 to 540° C., more preferably from 250 to 540° C., and most preferably from 400 to 540° C. The thermal spray powder is supplied to the working gas along the coaxial direction with the working gas at a feed rate of preferably from 1 to 100 g/minute, and more preferably from 10 to 100 g/minute. The distance between the substrate and the nozzle tip of the cold spray apparatus at the time of spraying is preferably from 5 to 100 mm, and more preferably from 10 to 40 mm. The traverse velocity of the nozzle of the cold spray apparatus is preferably from 5 to 300 mm/second, and more preferably from 5 to 150 mm/second. The thickness of the thermal spray coating formed is preferably from 50 to 1000 μm, more preferably from 100 to 500 μm, and most preferably from 100 to 300 μm.

In a case where a thermal spray powder of the above embodiment is used for the purpose of forming a thermal spray coating by the low pressure type cold spray mainly using compressed air as the working gas, the working gas is supplied to a cold spray apparatus at a pressure of preferably from 0.3 to 1 MPa, more preferably from 0.5 to 1 MPa, and most preferably from 0.7 to 1 MPa, and is heated to a temperature of preferably from 100 to 600° C., more preferably from 250 to 600° C., and most preferably from 400 to 600° C. The thermal spray powder is supplied to the working gas along the coaxial direction with the working gas at a feed rate of preferably from 1 to 200 g/minute, and more preferably from 10 to 100 g/minute. The distance between the substrate and the nozzle tip of the cold spray apparatus at the time of spraying is preferably from 5 to 100 mm, and more preferably from 10 to 40 mm. The traverse velocity of the nozzle of the cold spray apparatus is preferably from 5 to 300 mm/second, and more preferably from 5 to 150 mm/second. The thickness of the thermal spray coating formed is preferably from 50 to 1000 μm, more preferably from 100 to 500 μm, and most preferably from 100 to 300 μm.

Next, the present invention is specifically explained by demonstrating Examples and Comparative Examples.

Thermal spray powders according to Examples 1 to 10 and Comparative Examples 1 to 9 were prepared, each of which includes granulated and sintered cermet particles consisting of 12% by volume of cobalt with the balance of tungsten carbide. The thermal spray powders were each thermal sprayed under the first conditions shown at Table 1 to form a thermal spray coating having a thickness of 200 μm.

The thermal spray powders according to Example 11 and Comparative Examples 10 and 11 were prepared, each of which includes granulated and sintered cermet particles consisting of 25% by volume of an iron-based alloy with the balance of tungsten carbide. The thermal spray powders were each thermal sprayed under the second conditions shown in Table 2 to form a thermal spray coating.

The thermal spray powders according to Example 12 and Comparative Example 12 were prepared, each of which includes granulated and sintered cermet particles consisting of 12% by volume of cobalt with the balance of tungsten carbide. The thermal spray powders were each thermal sprayed under the third conditions shown in Table 3 to form a thermal spray coating.

The thermal spray powders according to Example 13 and Comparative Examples 13 to 15 were prepared, each of which includes granulated and sintered cermet particles consisting of 25% by volume of an iron-based alloy with the balance of tungsten carbide. The thermal spray powders were each thermal sprayed under the fourth conditions shown in Table 4 to form a thermal spray coating.

TABLE 1
First conditions

Thermal spray apparatus: HVOF thermal spray apparatus “JP-5000”
commercially available from Praxair/TAFA Ltd.
Oxygen flow rate: 1900 scfh (about 893 L/minute)
Kerosene flow rate: 5.1 gph (about 0.32 L/minute)
Thermal spraying distance: 380 mm
Barrel length of thermal spray apparatus: 4 inches (about 101.6 mm),
6 inches (about 152.4 mm), or 8 inches (about 203.2 mm)
Powder feeder: PL-25 commercially available from Technoserve Co., Ltd.
Feed rate of thermal spray powder: 50 to 60 g/minute
Kind of working gas: nitrogen gas
Feed rate of working gas: 7.9 L/min
Internal pressure of feeder: 0.30 psi (about 2 kPa)

TABLE 2
Second conditions

Thermal spray apparatus: cold spray thermal spray apparatus
“PCS-203” commercially available from Plasma Giken Co., Ltd.
Kind of working gas: helium
Working gas pressure: 3.0 MPa
Working gas temperature: 600° C.
Thermal spraying distance: 15 mm
Traverse velocity: 20 mm/second
Pass number of times: 1 pass
Feed rate of thermal spray powder: 50 g/minute
Substrate: SS400

TABLE 3
Third conditions

Thermal spray apparatus: cold spray thermal spray apparatus
“KM-CDS” commercially available from Inovati Co., Ltd. of the USA
Kind of working gas: helium
Working gas pressure: 0.6 MPa
Working gas temperature: 537° C.
Thermal spraying distance: 15 mm
Traverse velocity: 50 mm/second
Pass number of times: 1 pass
Feed rate of thermal spray powder: 10 g/minute
Substrate: SS400

TABLE 4
Fourth conditions

Thermal spray apparatus: cold spray thermal spray apparatus
“Dymet” commercially available from TWIN TC Co., Ltd. of Russia
Kind of working gas: air
Working gas pressure: 0.7 MPa
Working gas temperature: 600° C.
Thermal spraying distance: 20 mm
Traverse velocity: 5 mm/second
Pass number of times: 1 pass
Feed rate of thermal spray powder: 15 g/minute
Substrate: SS400

Details of the thermal spray powders of Examples 1 to 13 and Comparative Examples 1 to 15 and the thermal spray coatings formed therefrom are shown in Tables 5 to 8.

TABLE 5

| | Average particle | Average aspect | Compressive | | | |
|---|---|---|---|---|---|---|
| | size of | ratio of | strength of | Average particle | Dispersibility | |
| | granulated and | granulated and | granulated and | size of | of metal | |
| | sintered cermet | sintered | sintered cermet | primary | primary | Straight |
| | particles (μm) | cermet particles | particles (MPa) | particles (μm) | particles | ratio |
| Comparative | 4.7 | 1.27 | 300 | 2.0 | ≦0.40 | 0.24 |
| Example 1 | | | | | | |
| Example 1 | 12.7 | 1.10 | 300 | 2.0 | ≦0.40 | 0.30 |
| Example 2 | 12.7 | 1.15 | 300 | 2.0 | ≦0.40 | 0.28 |
| Example 3 | 12.7 | 1.23 | 300 | 1.9 | ≦0.40 | 0.26 |
| Example 4 | 12.7 | 1.25 | 300 | 5.5 | <0.40 | 0.25 |
| Example 5 | 12.7 | 1.25 | 900 | 2.0 | ≦0.40 | 0.25 |
| Example 6 | 12.7 | 1.25 | 300 | 2.0 | >0.40 | 0.25 |
| Comparative | 12.8 | 1.27 | 300 | 2.0 | >0.40 | 0.23 |
| Example 2 | | | | | | |
| Comparative | 12.7 | 1.26 | 300 | 7.0 | ≦0.40 | 0.23 |
| Example 3 | | | | | | |
| Example 7 | 12.2 | 1.25 | 300 | 6.1 | ≦0.40 | 0.25 |
| Comparative | 12.6 | 1.08 | 20 | 2.0 | ≦0.40 | 0.26 |
| Example 4 | | | | | | |
| Example 8 | 12.6 | 1.12 | 90 | 2.0 | ≦0.40 | 0.26 |
| Comparative | 30.6 | 1.12 | 300 | 2.0 | ≦0.40 | 0.25 |
| Example 5 | | | | | | |
| Comparative | 24.3 | 1.23 | 300 | 2.0 | ≦0.40 | 0.25 |
| Example 6 | | | | | | |
| Comparative | 12.7 | 1.31 | 300 | 1.9 | ≦0.40 | 0.14 |
| Example 7 | | | | | | |
| Example 9 | 12.7 | 1.23 | 300 | 1.9 | ≦0.40 | 0.26 |
| Comparative | 12.7 | 1.27 | 300 | 1.9 | ≦0.40 | 0.24 |
| Example 8 | | | | | | |
| Example 10 | 12.7 | 1.24 | 640 | 1.9 | ≦0.40 | 0.25 |
| Comparative | 12.7 | 1.32 | 570 | 1.9 | ≦0.40 | 0.22 |
| Example 9 | | | | | | |

| | | Barrel | | | Hardness of | Abrasion |
|---|---|---|---|---|---|---|
| | Average | length of | Deposition | | thermal | resistance of |
| | fractal | thermal spray | efficiency | | spray | thermal |
| | dimensionality | apparatus (inch) | (%) | Spitting | coating | spray coating |
| Comparative | 1.079 | 4 | 41.1 | presence | 1232 | 0.043 |
| Example 1 | | | | | | |
| Example 1 | 1.033 | 4 | 41.4 | absence | 1222 | 0.040 |
| Example 2 | 1.046 | 4 | 40.9 | absence | 1213 | 0.041 |
| Example 3 | 1.068 | 4 | 39.4 | absence | 1205 | 0.042 |
| Example 4 | 1.074 | 4 | 38.6 | absence | 1201 | 0.038 |
| Example 5 | 1.074 | 4 | 38.2 | absence | 1232 | 0.040 |
| Example 6 | 1.074 | 4 | 37.9 | presence | 1193 | 0.043 |
| Comparative | 1.079 | 4 | 37.7 | absence | 1187 | 0.045 |
| Example 2 | | | | | | |
| Comparative | 1.076 | 4 | 35.5 | presence | 1170 | 0.044 |
| Example 3 | | | | | | |
| Example 7 | 1.074 | 4 | 38.1 | absence | 1143 | 0.043 |
| Comparative | 1.027 | 4 | 40.1 | presence | 1137 | 0.045 |
| Example 4 | | | | | | |
| Example 8 | 1.038 | 4 | 39.9 | absence | 1233 | 0.042 |
| Comparative | 1.038 | 4 | 34.3 | absence | 1153 | 0.053 |
| Example 5 | | | | | | |
| Comparative | 1.068 | 4 | 37.1 | absence | 1103 | 0.049 |
| Example 6 | | | | | | |
| Comparative | 1.090 | 4 | — | presence | — | — |
| Example 7 | | | | | | |
| Example 9 | 1.068 | 6 | 38.1 | absence | 1253 | 0.049 |
| Comparative | 1.079 | 6 | 37.9 | presence | 1223 | 0.050 |
| Example 8 | | | | | | |
| Example 10 | 1.071 | 8 | 36.6 | absence | 1280 | 0.043 |
| Comparative | 1.093 | 8 | 36.3 | presence | 1277 | 0.050 |
| Example 9 | | | | | | |

TABLE 6

| | Average | Average | | Average | | | | | |
|---|---|---|---|---|---|---|---|---|---|
| | particle | aspect | Compressive | particle | | | | | |
| | size of | ratio of | strength of | size of | Dispersibility | | | Thickness of | |
| | granulated and | granulated | granulated and | primary | of metal | | Average | thermal | Hardness of |
| | sintered cermet | and sintered | sintered cermet | particles | primary | Straight | fractal | spray | thermal spray |
| | particles (μm) | cermet particles | particles (MPa) | (μm) | particles | ratio | dimensionality | coating (μm) | coating |
| Example 11 | 14.2 | 1.23 | 300 | 0.2 | ≦0.40 | 0.28 | 1.068 | 180 | 998 |
| Comparative | 14.3 | 1.31 | 300 | 0.2 | ≦0.40 | 0.23 | 1.090 | 130 | 930 |
| Example 10 | | | | | | | | | |
| Comparative | 14.3 | 1.23 | 300 | 0.2 | >0.40 | 0.27 | 1.068 | 170 | 830 |
| Example 11 | | | | | | | | | |

TABLE 7

| | Average | Average | | Average | | | | | |
|---|---|---|---|---|---|---|---|---|---|
| | particle | aspect | Compressive | particle | | | | | |
| | size of | ratio of | strength of | size of | Dispersibility | | | Thickness of | |
| | granulated and | granulated | granulated and | primary | of metal | | Average | thermal | Hardness of |
| | sintered cermet | and sintered | sintered cermet | particles | primary | Straight | fractal | spray | thermal spray |
| | particles (μm) | cermet particles | particles (MPa) | (μm) | particles | ratio | dimensionality | coating (μm) | coating |
| Example 12 | 14.2 | 1.23 | 300 | 0.2 | ≦0.40 | 0.29 | 1.068 | 70 | 1213 |
| Comparative | 14.3 | 1.27 | 300 | 0.2 | >0.40 | 0.24 | 1.079 | 30 | peeling |
| Example 12 | | | | | | | | | |

TABLE 8

| | Average | Average | | Average | | | | | |
|---|---|---|---|---|---|---|---|---|---|
| | particle | aspect | Compressive | particle | | | | | |
| | size of | ratio of | strength of | size of | Dispersibility | | | Thickness of | |
| | granulated and | granulated | granulated and | primary | of metal | | Average | thermal | Hardness of |
| | sintered cermet | and sintered | sintered cermet | particles | primary | Straight | fractal | spray | thermal spray |
| | particles (μm) | cermet particles | particles (MPa) | (μm) | particles | ratio | dimensionality | coating (μm) | coating |
| Example 13 | 14.2 | 1.23 | 300 | 0.2 | ≦0.40 | 0.28 | 1.068 | 210 | 800 |
| Comparative | 14.3 | 1.31 | 300 | 0.2 | ≦0.40 | 0.23 | 1.090 | 130 | 770 |
| Example 13 | | | | | | | | | |
| Comparative | 14.3 | 1.23 | 300 | 0.2 | >0.40 | 0.27 | 1.068 | 200 | 670 |
| Example 14 | | | | | | | | | |
| Comparative | 14.3 | 1.31 | 300 | 0.2 | >0.40 | 0.23 | 1.090 | 60 | 670 |
| Example 15 | | | | | | | | | |

The columns entitled “Average particle size of granulated and sintered cermet particles” in Tables 5 to 8 show the results of measurement of an average particle size (volume average size) of each thermal spray powder of Examples 1 to 13 and Comparative Examples 1 to 15 by using a laser diffraction/scattering particle size distribution analyzer “LA-300” commercially available from Horiba, Ltd.

The columns entitled “Average aspect ratio of granulated and sintered cermet particles” in Tables 5 to 8 show the results of measurement of an average aspect ratio of granulated and sintered cermet particles contained in each thermal spray powder of Examples 1 to 13 and Comparative Examples 1 to 15 by analysis of scanning electron microscope images.

The columns entitled “Compressive strength of granulated and sintered cermet particles” in Tables 5 to 8 show the results of measurement of a compressive strength of granulated and sintered cermet particles contained in each thermal spray powder of Examples 1 to 13 and Comparative Examples 1 to 15. Specifically, it shows a compressive strength δ [MPa] of granulated and sintered cermet particles which is calculated according to the formula: δ=2.8×L/π/d². In the above formula, L represents critical load [N], and d represents an average particle size [mm] of the thermal spray powder. Critical load is a value of compressive load applied to the granulated and sintered cermet particles at the time of abruptly increasing a displacement amount of an indenting tool when compressive load increasing at a constant velocity is applied to the granulated and sintered cermet particles by the indenting tool. Critical load was measured by using a minute compression tester “MCTE-500” commercially available from Shimadzu Corporation.

The columns entitled “Average particle size of primary particles” in Tables 5 to 8 show the results of measurement of an average particle size (average Feret's diameter) of primary particles constituting the granulated and sintered cermet particles contained in each thermal spray powder of Examples 1 to 13 and Comparative Examples 1 to 15 by using scanning electron microscope.

The columns entitled “Dispersibility of metal primary particles” in Tables 5 to 8 show whether or not a value is 0.40 or lower, which value is obtained by dividing a number average size of metal primary particles constituting the granulated and sintered cermet particles contained in each thermal spray powder of Examples 1 to 13 and Comparative Examples 1 to 15 by a volume average size of the metal primary particles.

The columns entitled “Straight ratio” in Tables 5 to 8 show a value obtained by dividing the maximum thickness of a thermal spray coating obtained, when 150 grams of each thermal spray powder of Examples 1 to 13 and Comparative Examples 1 to 15 is subjected to thermal spot spraying, by the length of the longest of line segments each of which has both ends thereof on a contour of the thermal spray coating.

The columns entitled “Average fractal dimensionality” in Tables 5 to 8 show the results of measurement of an average fractal dimensionality of granulated and sintered cermet particles contained in each thermal spray powder of Examples 1 to 13 and Comparative Examples 1 to 15. The average fractal dimensionality was specifically measured by using an image analysis software Image-Pro Plus available from Nippon Roper K.K. according to a divider method based on secondary electronic images (1000 to 2000 magnifications) by scanning electron microscope of five particles having a particle size of within ±3 μm of average particle size among the granulated and sintered cermet particles contained in each thermal spray powder of Examples 1 to 13 and Comparative Examples 1 to 15.

The column entitled “Barrel length of thermal spray apparatus” in Table 5 shows the barrel length of HVOF thermal spray apparatus used at the time of thermal spraying each thermal spray powder of Examples 1 to 10 and Comparative Examples 1 to 9.

The column entitled “Coating efficiency” in Table 5 shows a percentage value which is obtained by dividing an amount of the thermal spray coating formed from each thermal spray powder of Examples 1 to 10 and Comparative Examples 1 to 9 by the weight of thermal spray powder which was thermal sprayed. The symbol “-” in the column represents that a film was not able to be formed.

The column entitled “Spitting” in Table 5 shows the presence or absence of generation of spitting when each thermal spray powder of Examples 1 to 10 and Comparative Examples 1 to 9 was continuously thermal sprayed for five minutes.

The columns entitled “Thickness of thermal spray coating” in Tables 6 to 8 show the thickness of the thermal spray coating formed from each thermal spray powder of Examples 11 to 13 and Comparative Examples 10 to 15. Although not shown in Table 5, the thickness of the thermal spray coating formed from each thermal spray powder of Examples 1 to 6 and 8 to 10 and Comparative Examples 1 to 9 was all 200 μm.

The columns entitled “Hardness of thermal spray coating” in Tables 5 to 8 show the results of measurement of the Vickers hardness (Hv 0.2) of the thermal spray coating formed from each thermal spray powder of Examples 1 to 13 and Comparative Examples 1 to 15 by using a minute hardness tester HMV-1 commercially available from Shimadzu Corporation. The symbol “-” in the columns represents that a film was not able to be formed, and “peeling” represents that a measurement was not able to be conducted because the film peeled away just after film formation.

The column entitled “Abrasion resistance of thermal spray coating” in Table 5 shows a value which is obtained by dividing an abrasion volume loss of the thermal spray coating formed from each thermal spray powder of Examples 1 to 10 and Comparative Examples 1 to 9 based on an abrasive wheel wear test according to Japanese Industrial Standards JIS H8682-1 using a Suga abrasion tester by an abrasion volume loss of carbon steel SS400 based on the same abrasive wheel wear test. The symbol “-” in the column represents that a film was not able to be formed.

1. A thermal spray powder comprising: granulated and sintered cermet particles, wherein:
the granulated and sintered cermet particles have an average particle size of from 5 to 25 μm;
the granulated and sintered cermet particles have a compressive strength of 50 MPa or higher; and
the granulated and sintered cermet particles have a straight ratio of 0.25 or higher, wherein the straight ratio is defined as a value resulting from dividing the maximum thickness of a thermal spray coating obtained, when 150 grams of the thermal spray powder is subjected to thermal spot spraying, by the length of the longest of line segments each of which has both ends thereof on a contour of the thermal spray coating.

2. The thermal spray powder according to claim 1, wherein the granulated and sintered cermet particles have an average aspect ratio of 1.25 or lower.

3. The thermal spray powder according to claim 1, wherein primary particles constituting the granulated and sintered cermet particles have an average particle size of 6.0 μm or lower.

4. The thermal spray powder according to claim 1, wherein metal primary particles constituting the granulated and sintered cermet particles have a dispersibility of 0.40 or lower, wherein the dispersibility is defined as a value obtained by dividing a number average size of the metal primary particles by a volume average size of the metal primary particles.

5. The thermal spray powder according to claim 1, wherein the compressive strength of the granulated and sintered cermet particles is 1000 MPa or lower.

6. The thermal spray powder according to claim 1, wherein the granulated and sintered cermet particles have an average fractal dimensionality of 1.075 or lower.

7. A method comprising: forming a thermal spray coating, wherein the thermal spray powder according to claim 1 is subjected to high-velocity flame spraying to form a thermal spray coating.

8. A method comprising: forming a thermal spray coating, wherein the thermal spray powder according to claim 1 is subjected to cold spraying to form a thermal spray coating.
